(19) United States
(12) Patent Application Publication
(10) Pub. No.: US 2006/0106974 A1
(43) Pub. Date: May 18, 2006

(54) DYNAMIC RANDOM ACCESS MEMORY CONTROLLER AND VIDEO SYSTEM

(76) Inventors: Ying-Chih Yang, Hsinchu City (TW); Yuan-Ning Chen, Taipei County (TW); Jen-Yi Liao, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,167

(22) Filed: Feb. 5, 2005

(30) Foreign Application Priority Data
Nov. 15, 2004 (TW) 93134879

(51) Int. Cl. G06F 12/00

(52) U.S. Cl. 711/105; 711/201

(57) ABSTRACT

A dynamic random access memory controller is suitable in controlling a first dynamic random access memory and a second dynamic random access memory, which two memory capacities are not the same. The judging circuit of the dynamic random access memory controller receives and judges whether or not a system addressing signal falls within a preset range, and outputs a judging signal. Furthermore, the transforming and shielding circuit transforms the system addressing signal and byte enable signal in accordance with the judging signal, and therefore obtains a memory addressing signal and a shielding signal for addressing the first and the second dynamic random access memories. Furthermore, the data interface circuit, in accordance with the judging signal, buffers or separates a system writing-in data signal, or, buffers or merges the memory data signal.

### CROSS-REFERENCE TO RELATED APPLICATION

This application claims the priority benefit of Taiwan application Serial No. 93134879, filed Nov. 15, 2004.

### BACKGROUND OF THE INVENTION

1. Field of the Invention

This invention generally relates to a dynamic random access memory (DRAM) controller and a video system, and especially to a video system on which two different memory capacities of dynamic random access memory can be disposed, and a dynamic random access memory controller which can control two dynamic random access memories with different memory capacity.

2. Description of Related Art

Due to research development in recent years, memory capacity of a digital Versatile disc (DVD) increases greatly. DVD belongs to an optical data memory disc, which makes use of low power laser to read-out a data from the disc. Comparing with a read-only memory disc (CD-ROM), DVD possesses more larger memory capacity, and can be used to memorize video, audio and digital data. Moreover, owing to the reproduction time is very long, DVD is used widely in recording movie and music information recently.

Synchronous DRAM (SDRAM) is used often for memory in chipset of DVD player. Wherein, the production with ×16 width is popular in the market. However, the production with ×32 width is often required owing to the requirement of frequency width in DVD player. Therefore two synchronous DRAMs, which have same capacity with a parallel pattern, are usually used when designers of DVD player make the designs.

However it is not necessary that all the memory will be used. For example, if two memories with each 1×16 MB are not enough in the usage of an application program, two memories with 4×16 MB will be implemented generally. But when connecting between the memories, in general, two inner memories with each 1×16 MB are connected in parallel or in series, and two memories with 4×16 MB are connected in parallel or in series. Furthermore, since the memories with the same memory capacity have to be used in the design, the opportunity of flexibly implementing memories with different memory capacities is lost, and manufacturing cost can increase also.

### SUMMARY OF THE INVENTION

An object of the present invention is to provide a dynamic random access memory controller, for obtaining a corresponding address of a system addressing signal in two dynamic random access memories with different memory capacities, in accordance with the system addressing signal of a data which will be written-in or read-out.

Another object of the present invention is to provide a video system, wherein in order to decrease the manufacturing cost, the implementation of two dynamic random access memories with different memory capacities can be adjusted in accordance with the market prices of the dynamic random access memories.

The present invention provides a dynamic random access memory controller, for controlling a first dynamic random access memory and a second dynamic random access memory. Wherein, the first memory capacity of the first dynamic random access memory is not the same as the second memory capacity of the second dynamic random access memory. The dynamic random access memory controller includes a judging circuit, a transforming and shielding circuit and a data interface circuit. The judging circuit receives a system addressing signal and judges whether or not it falls within a preset range, further outputs a judging signal. The transforming and shielding circuit receives the judging signal, the system addressing signal and a byte enable signal, and transforms the system addressing signal and the byte enable signal in accordance with the judging signal, and further obtains a memory addressing signal and a shielding signal for addressing the first dynamic random access memory and the second dynamic random access memory. The data interface circuit, in accordance with the judging signal, obtains a memory data signal by buffering or separating a system write-in data signal, or obtains a system read-out data signal by buffering or merging the memory data signal.

In accordance with the description of the preferred embodiments of the present invention, when it is judged as that the system addressing signal falls within the preset range, the dynamic random access memory controller accesses to the first dynamic random access memory and the second dynamic random access memory at same time.

In accordance with the description of the preferred embodiments of the present invention, when a situation of the system addressing signal falling out of the preset range is judged, the dynamic random access memory controller accesses to the first dynamic random access memory.

In accordance with the description of the preferred embodiments of the present invention, when the situation of the system addressing signal falling within the preset range is judged, the dynamic random access memory controller accesses to the first dynamic random access memory.

In accordance with the description of the preferred embodiments of the present invention, when the situation of the system addressing signal falling out of the preset range is judged, the dynamic random access memory controller accesses to the second dynamic random access memory.

Moreover the present invention provides a video system, which includes a system bus, a first dynamic random access memory, a second dynamic random access memory and a dynamic random access memory controller. The system bus includes a system addressing signal and a byte enable signal. The first dynamic random access memory includes a first memory capacity. The second dynamic random access memory includes a second memory capacity, and the first memory capacity is not equal to the second memory capacity. In accordance with the judge signal, the system addressing signal and the byte enable signal, the above mentioned dynamic random access memory controller addresses the first dynamic random access memory and the second dynamic random access memory, and further decides to buffer or separate a write-in data signal of the system, or to buffer or merge a memory data signal.

Since the present invention can utilize two dynamic random memories with different capacities, the implementation of the memories can be adjusted according to the prices of the dynamic random access memories in video system such as DVD player or MPEG decoding platform, so as to reduce the cost.

### BRIEF DESCRIPTION OF THE DRAWINGS

The above is a brief description of some deficiencies in the prior art and advantages of the present invention. Other features, advantages and embodiments of the invention will be apparent to those skilled in the art from the following description, accompanying drawings and appended claims.

FIG. 1A is a block diagram, schematically shows a circuit of a video system according to an embodiment of the present invention.

FIG. 1B is a drawing, schematically shows a view of a first dynamic random access memory and a second dynamic random access memory with a series connection, according to an embodiment of the present invention.

FIG. 1C is a drawing, schematically shows a view of a first dynamic random access memory and a second dynamic random access memory with a parallel connection, according to an embodiment of the present invention.

FIG. 2 is a drawing, schematically shows a circuit of a dynamic random access memory controller, according to an embodiment of the present invention.

FIG. 3 is a drawing, schematically shows a multi-signal waveforms of a dynamic random access memory controller, according to an embodiment of the present invention.

### DESCRIPTION OF THE PREFERRED EMBODIMENTS

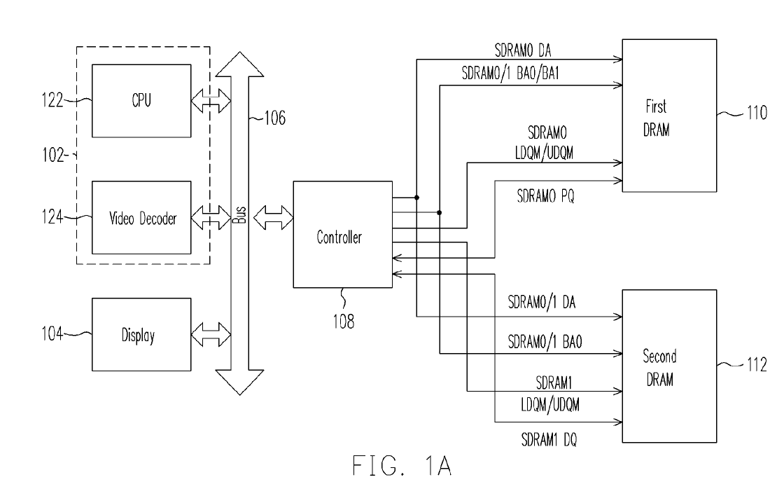

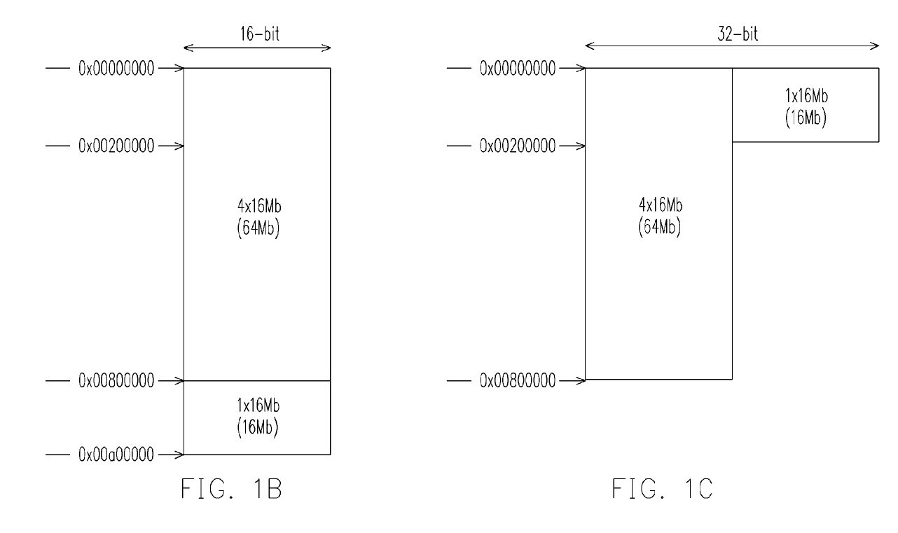

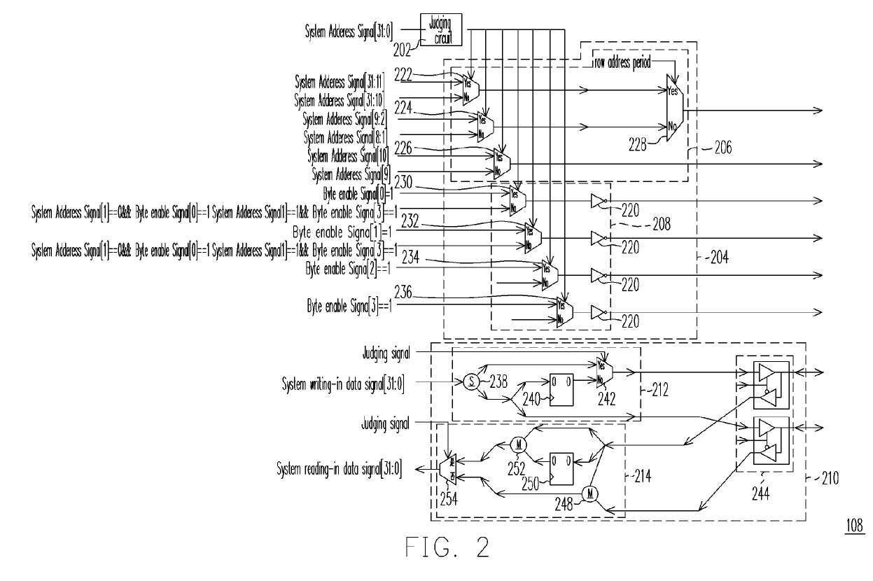

FIG. 1A is a block diagram, schematically shows a circuit of a video system according to an embodiment of the present invention. The video system 110 includes a processing module 102, a display 104, a system bus 106, a dynamic random access memory (DRAM) controller 108, a first dynamic random access memory 110 and a second dynamic random access memory 112. Wherein, the video system 100 can be, for example, a DVD player or an MPEG platform.

In the embodiment of the present invention, the processing module 102 can for example include a central processing unit (CPU) 122 and a video decoder 124, and the processing module 102 outputs a system addressing signal and a byte enable signal to the system bus 106.

In accordance with FIG. 1A, FIG. 1B and FIG. 1C of the embodiment of the present invention, the first dynamic random access memory 110 includes a first memory capacity, the second dynamic random access memory 112 includes a second memory capacity, and the first memory capacity is not the same as the second memory capacity.

In FIG. 1B and FIG. 1C, although only 4×16 MB (64 MB) and 1×16 MB (16 MB) are illustrated, it is to be understood that the embodiment is presented by way of example and not by way of limitation. As shown in FIG. 1B, a dynamic random access memory with 4×16 MB (64 MB) and a dynamic random access memory with 1×16 MB (16 MB) are in a series connection, wherein the column addressing widths of the two memories are all 16 bit width as shown in Table 1. Moreover as shown in FIG. 1C, the dynamic random access memory with 4×16 MB (64 MB) and the dynamic random access memory with 1×16 MB (16 MB) are in a parallel connection, wherein 32 bit width is presented at front region 4 MB space and 16 bit width is presented at the other region of 6 MB space.

TABLE 1

| | 1M × 16 | 16M × 4 | 8M × 8 | 4M × 16 |
|---|---|---|---|---|
| Configuration | 512k * 16 * | 4M * 4 * 4 | 2M * 8 * 4 | 1M * 16 * 4 |
| | 2 bank | bank | bank | bank |
| Refresh count | 2k or 4k | 4k | 4k | 4k |
| Row | 2k(A0-A10) | 4k(A0-A11) | 4k(A0-A11) | 4k(A0-A11) |
| addressing | | | | |
| Bank | 2(BA) | 4(BA0, | 4(BA0, | 4(BA0, |
| addressing | | BA1) | BA1) | BA1) |
| Column | 256(A0-A7) | 1k(A0-A9) | 512(A0-A8) | 256(A0-A7) |
| addressing | | | | |

In the embodiment of the present invention, for example, if a dynamic random access memory with 8×16 MB (128 MB) and a dynamic random access memory with 1×6 MB (16 MB) are in a parallel connection, 32 bit width is presented at front 4 MB space and 16 bit width is presented at the rest 14 MB space. Wherein, since the column address of the dynamic random access memory with 1×16 MB is A7-A0 and the column address of the dynamic random access memory with 8×16 MB is A8-A0, the column address can be mapped to the region after 8+2 Mbytes, as shown in Table 2 and Table 3.

TABLE 2

| | 32M × 4 | 16M × 8 | 8M × 16 |
|---|---|---|---|
| Configuration | 8M * 4 * 14 bank | 4M * 8 * 4 bank | 2M * 16 * 4 bank |
| Refresh count | 4k | 4k | 4k |
| Row | 4k(A0-A11) | 4k(A0-A11) | 4k(A0-A11) |
| addressing | | | |
| Bank | 4(BA0, BA1) | 4(BA0, BA1) | 4(BA0, BA1) |
| addressing | | | |
| Column | 2k(A0-A9, A11) | 1k(A0-A9) | 512(A0-A8) |
| addressing | | | |

TABLE 3

| | 64M × 4 | 32M × 8 | 16M × 16 |
|---|---|---|---|
| Configuration | 16M * 4 * 4 bank | 8M * 8 * 4 bank | 8M * 16 * 4 bank |
| Refresh count | 8k | 8k | 8k |
| Row | 8k(A0-A12) | 8k(A0-A12) | 8k(A0-A12) |
| addressing | | | |
| Bank | 4(BA0, BA1) | 4(BA0, BA1) | 4(BA0, BA1) |
| addressing | | | |
| Column | 2k(A0-A9, A11) | 1k(A0-A9) | 512(A0-A8) |
| addressing | | | |

Further referring to FIG. 1A and FIG. 2, FIG. 2 is a drawing, schematically shows a dynamic random access memory controller according to an embodiment of the present invention. The dynamic random access memory controller 108 includes a judging circuit 202, a transforming and shielding circuit 204, and a data interface circuit 210.

In the embodiment of the present invention, the judging circuit 202, which is electrically connected with the system bus 106, receives and judges whether or not the system addressing signal falls within the preset range, and further exports a judging signal. Wherein, the preset range can be, for example, the first memory capacity or the second memory capacity if the two memories are in a series connection, or the range of 32 bit width in forgoing mentioned two memories if they are in a parallel connection.

In the embodiment of the present invention, if the system addressing signal falls within the preset range, the dynamic random access memory controller 108 can access to the first dynamic random access memory 110 and the second dynamic random access memory 112 at the same time, or access to the first dynamic random access memory 110 alone.

On the contrary, if the system addressing signal falls beyond the preset range, the dynamic random access memory controller 108 can access to the first dynamic random access memory 110 or access to the second dynamic random access memory 112.

The transforming and shielding circuit 204 includes a transforming circuit 206 and a shielding circuit 208. The transforming circuit 206 receives a system addressing signal and the judging signal, transforms the system addressing signal according to the judging signal for obtaining a memory addressing signal. Wherein, the memory addressing signal is the corresponding addresses of the system addressing signals, locating in the first dynamic random access memory 110 and the second dynamic random access memory 112.

In the embodiment of the present invention, the transforming circuit 206 can include, for example, a plurality of multiplexers 222, 224, 226 and 228.

The shielding circuit 208 receives a byte enable signal, a system addressing signal and a judging signal, transforms the byte enable signal and the system addressing signal according to the judging signal, for obtaining a shielding signal.

In the embodiment of the present invention, the shielding circuit 208 can be can be comprised of, for example, a plurality of multiplexers 230, 232, 234, 236 and a plurality of NOT gates 220.

The data interface circuit 210 includes a data buffering separating circuit 212 and a data buffering merging circuit 214. The data buffering separating circuit 212 buffers or separates a system writing-in data signal according to the judging signal, and obtains a memory data signal. The data buffering merging circuit 214 buffers or merges the memory data signal according to the judging signal, and obtains a system reading-out data signal. Further, the data interface circuit 210 includes a transmitting interface circuit 244, which is coupled to the data buffering separating circuit 212 and the data buffering merging circuit 214.

A description as below is for a situation of parallel connection of a dynamic random access memory with 64 MB+16 MB.

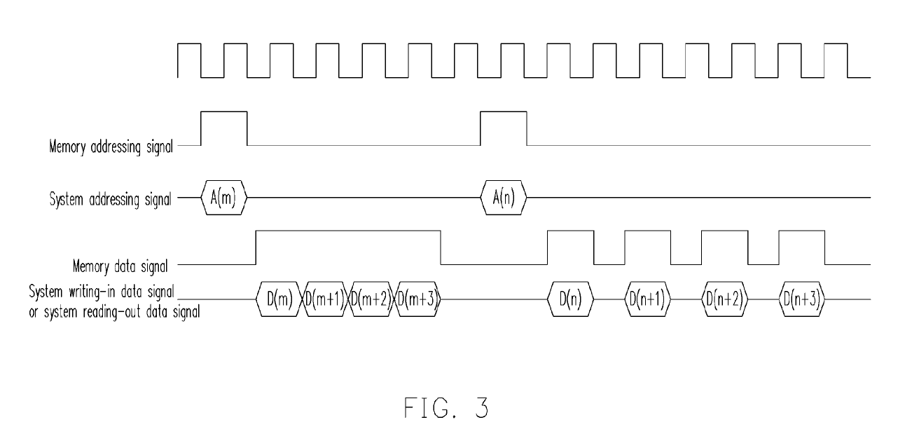

As shown in FIG. 2, the judging circuit 202 receives a system addressing signal [31:0], judges whether or nor it is beyond 4 MB, and outputs a judging signal. The multiplexer 222 of the transforming circuit 206 receives a system addressing signal [31:11] and a system addressing signal [31:0] as shown in FIG. 3, and outputs the system addressing signal [31:11] if the system addressing signal [31:0] as the judging signal is not beyond the preset range 4 MB; On the contrary, the multiplexer 222 of the transforming circuit 206 outputs the system addressing signal [31:10] if the system addressing signal [31:0] as the judging signal is beyond the preset range 4 MB.

The multiplexer 224 decides in accordance with the judging signal to output a system addressing signal [9:2] (not beyond 4 MB) or output a system addressing signal [8:1] (beyond 4 MB). The multiplexer 226 decides in accordance with the judging signal to output a system addressing signal [10] (not beyond 4 MB) or output a system addressing signal [9] (beyond 4 MB).

In the embodiment of the present invention, the multiplexer 222 and the multiplexer 224 are coupled to the multiplexer 228 and function as two input terminals of the multiplexer 228. The multiplexer 228, in accordance with the period of the receiving row address, sequentially outputs the memory addressing signals SDRAM 0/1 DA of a row address [11:0] and a column address (7:0) as shown in FIG. 3. Moreover, the multiplexer 226 outputs memory addressing signals SDRAM 0/1 BA0 as shown in FIG. 3.

In the shielding circuit 208, the multiplexer 230 outputs a judging result of a byte enable signal (0)==1 if the system addressing signal [31:0] in the judging signal is not beyond 4 MB. On the contrary, if the system addressing signal [31:0] as the judging signal is beyond 4 MB, outputs a judging result of a system addressing signal [1]==0 and the judging result of the byte enable signal (0)==1, or outputs a judging result of a system addressing signal [1]==1 and a judging result of a byte enable signal [3]==1. Further more a shielding signal SDRAM 0 LDQM is outputted after performing an inverse by NOT gate 220.

The multiplexer 232, outputs a judging result of a byte enable signal [1]==1 if the system addressing signal [31:0] as the judging signal is not beyond 4 MB; otherwise, if the system addressing signal [31:0] as the judging signal is beyond 4 MB, outputs the judging result of the system addressing signal [1]==0 and the judging result of the byte enable signal [0]==1, or outputs the judging result of the system addressing signal [1]==1 and the judging result of the byte enable signal [3]==1. Further more the shielding signal SDRAM 0 UDQM is outputted after performing an inverse by NOT gate 220.

The multiplexer 234, outputs a judging result of a byte enable signal [2]==1 if the system addressing signal [31:0] as the judging signal is not beyond 4 MB; otherwise, outputs a logical value 1 if the system addressing signal [31:0] as the judging signal is beyond 4 MB. Further more a shielding signal SDRAM 1 LDQM is outputted after performing an inverse by NOT gate 220.

The multiplexer 236, outputs a judging result of a byte enable signal [3]==1 if the system addressing signal [31:0] as the judging signal is not beyond 4 MB; on the contrary, outputs a logical value 1 if the system addressing signal [31:0] as the judging signal is beyond 4 MB. Further more a shielding signal SDRAM 1 UDQM is outputted after performing the reverse phase by NOT gate 220.

Further referring to FIG. 2, the data buffering separating circuit 212 includes, for example, a separating unit 238, a flip-flop device 240 and a multiplexer 242. The data buffering separating circuit 212, in accordance with the judging signal, decides the bit widths for writing-in the first dynamic random access memory 110 and the second dynamic random access memory 112. If the system addressing signal [31:0] as the judging signal is not beyond 4 MB (or it is beyond 4 MB and is in an even clock), the system writing-in data signal [31:0] is then separated into two signals of 16-bit widths by the separating unit 238, and a memory data signal SDRAM 0 DQ (15:0) as shown in FIG. 3 and a memory data signal SDRAM 1 DQ (15:0) as shown in FIG. 3 are output respectively through the transmitting interface circuit 244.

If the system addressing signal [31:0] as the judging signal is beyond 4 MB, the transforming interface circuit 244 outputs a memory data signal SDRAM 0 DQ [15:0] which is transmitted from the flip-lope device 240, as shown in FIG. 3.

The data buffering merging circuit 214 includes, for example, a merging units 248 and 252, a flip-lope device 250 and a multiplexer 254. The data buffering merging circuit 212, in accordance with the judging signal, decides the bit widths for reading-out from the first dynamic random access memory 110 and the second dynamic random access memory 1112.

If the system addressing signal [31:0] as the judging signal is not beyond 4 MB, the transmitting interface circuit 244 reads-out the memory data signal SDRAM 0 DQ [15:0] and the memory data signal SDRAM 1 DQ [15:0], and outputs the system reading-out data signal [31:0] through the merging unit 248 and 252, and the multiplexer 254, as shown in FIG. 3. Otherwise, the transmitting interface circuit 244 reads-out the memory data signal SDRAM 0 DQ [15:0] and outputs the system reading-out data signal [31:0] through the merging unit 252, the flip-lope device 250 and the multiplexer 254, as shown in FIG. 3.

In summary, the dynamic random access memory controller and the video system of the present invention can control the writing-in and reading-out to two dynamic random access memories which have the different memory capacities, so that the implementation of the memory can be adjusted according to the price of the dynamic random access memory in video system such as DVD player or MPEG decoding platform, and the cost is therefore reduced.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A dynamic random access memory controller, suitable for controlling a first dynamic random access memory and a second dynamic random access memory, wherein the first dynamic random access memory has a first memory capacity, the second dynamic random access memory has a second memory capacity, and the first memory capacity does not equal to the second memory capacity, the dynamic random access memory controller comprising:
a judging circuit, for receiving and judging whether or not a system addressing signal falls within a preset range, and outputting a judging signal;
a transforming and shielding circuit, electrically coupled to the judging circuit, the first dynamic random access memory and the second dynamic random access memory, for receiving the judging signal, the system addressing signal and a byte enable signal, and transforming the system addressing signal and the byte enable signal in accordance with the judging signal, for obtaining a memory addressing signal and a shielding signal, further addressing the first dynamic random access memory and the second dynamic random access memory; and
a data interface circuit, electrically coupled to the judging circuit, the first dynamic random access memory and the second dynamic random access memory, for buffering or separating a system writing-in data signal to obtain a memory data signal, or buffering or merging the memory data signal to obtain a system reading-out data signal, in accordance with the judging signal.

2. The dynamic random access memory controller of claim 1, wherein, if a situation of the system addressing signal falling in the preset range is judged, the dynamic random access memory controller accesses to the first dynamic random access memory and the second dynamic random access memory at same time.

3. The dynamic random access memory controller of claim 2, wherein, when the system addressing signal falling beyond the preset range is judged, the dynamic random access memory controller accesses to the first dynamic random access memory.

4. The dynamic random access memory controller of claim 1, wherein if a situation of the system addressing signal falling in the preset range is judged, the dynamic random access memory controller accesses to the first dynamic random access memory.

5. The dynamic random access memory controller of claim 4, wherein, if a situation of the system addressing signal falling beyond the preset range is judged, the dynamic random access memory controller accesses to the second dynamic random access memory.

6. The dynamic random access memory controller of claim 1, wherein the transforming and shielding circuit comprises:
a transforming circuit, for receiving the system addressing signal and the judging signal, and in accordance with the judging signal for transforming the system addressing signal to obtain the memory addressing signal, wherein the memory addressing signal includes corresponding addresses of the system addressing signals located in the first dynamic random access memory and the second dynamic random access memory; and a shielding circuit, for receiving the byte enable signal, the system addressing signal and the judging signal, and in accordance with the judging signal for transforming the byte enable signal and the system addressing signal to obtain the shielding signal.

7. The dynamic random access memory controller of claim 1, wherein the data interface circuit comprises:
a data buffering separating circuit, for buffering or separating the system writing-in data signal in accordance with the judging signal, and obtaining the memory data signal: and
a data buffering merging circuit, for buffering or merging the memory data signal in accordance with the judging signal, and obtaining the system reading-out data signal.

8. A video system, comprising:
a system bus, comprising a system addressing signal and a byte enable signal;
a first dynamic random access memory, having a first memory capacity;
a second dynamic random access memory, having a second memory capacity, wherein the first memory capacity does not equal the second memory capacity; and
a dynamic random access memory controller, electrically coupled to the first dynamic random access memory and the second dynamic random access memory, for addressing the first dynamic random access memory and the second dynamic random access memory, and deciding to buffer or separate a system writing-in data signal, or to buffer or merge a memory data signal, in accordance with a judge signal, the system addressing signal and the byte enable signal.

9. The video system of claim 8, wherein the dynamic random access memory controller comprises:
a judging circuit, for receiving and judging whether or not the system addressing signal falls within a preset range, and outputting the judging signal;
a transforming and shielding circuit, electrically coupled to the judging circuit, the first dynamic random access memory and the second dynamic random access memory, for receiving the judging signal, the system addressing signal and the byte enable signal, transforming the system addressing signal and the byte enable signal in accordance with the judging signal for obtaining a memory addressing signal and a shielding signal, further addressing the first dynamic random access memory and the second dynamic random access memory; and
a data interface circuit, electrically coupled to the judging circuit, the first dynamic random access memory and the second dynamic random access memory, for buffering or separating the system writing-in data signal to obtain the memory data signal, or buffering or merging the memory data signal to obtain a system reading-out data signal, in accordance with the judging signal.

10. The video system of claim 9, wherein, when the system addressing signal falls within the preset range, the dynamic random access memory controller accesses to the first dynamic random access memory and the second dynamic random access memory at same time.

11. The video system of claim 10, wherein, when the system addressing signal falls beyond the preset range, the dynamic random access memory controller accesses to the first dynamic random access memory.

12. The video system of claim 9, wherein, when the system addressing signal falls within the preset range, the dynamic random access memory controller accesses to the first dynamic random access memory.

13. The video system of claim 12, wherein, when the system addressing signal falls beyond the preset range, the dynamic random access memory controller accesses to the second dynamic random access memory.

14. The video system of claim 9, wherein the transforming and shielding circuit comprises:
a transforming circuit, for receiving the system addressing signal and the judging signal, and in accordance with the judging signal for transforming the system addressing signal to obtain the memory addressing signal, wherein the memory addressing signal includes corresponding addresses of the system addressing signals located in the first dynamic random access memory and the second dynamic random access memory; and
a shielding circuit, for receiving the byte enable signal, the system addressing signal and the judging signal, and in accordance with the judging signal for transforming the byte enable signal and the system addressing signal to obtain the shielding signal.

15. The video system of claim 9, wherein the data interface circuit comprises:
a data buffering separating circuit, for buffering or separating the system writing-in data signal in accordance with the judging signal, and obtaining the memory data signal: and
a data buffering merging circuit, for buffering or merging the memory data signal in accordance with the judging signal, and obtaining the system reading—out data signal.
